(19) United States
(12) Patent Application Publication
(10) Pub. No.: US 2013/0002781 A1
(43) Pub. Date: Jan. 3, 2013

(54) IMAGE FORMING APPARATUS, IMAGE FORMING METHOD, AND COMPUTER-READABLE STORAGE MEDIUM

(76) Inventor: Shinya KAMIJO, Ibaraki (JP)

(21) Appl. No.: 13/527,049

(22) Filed: Jun. 19, 2012

(30) Foreign Application Priority Data
Jun. 29, 2011 (JP) 2011-144905

(51) Int. Cl. B41J 2/385

(52) U.S. Cl. 347/118

(57) ABSTRACT

An image forming apparatus includes a polygon mirror configured to scan a photosensitive element with a writing beam; a developing unit configured to develop a latent image formed by the writing beam on the photosensitive element to form a visualized image corresponding to image data; a transfer unit configured to transfer the visualized image onto an image recording medium; a conveying unit configured to convey the image recording medium to a transfer position; and a writing control unit configured to control a rotation speed of the polygon mirror and a writing clock frequency of the writing beam so that a sub-scanning direction scale factor of the visualized image transferred onto the image recording medium having the second thickness is matched to a sub-scanning direction scale factor of the visualized image transferred onto the image recording medium having the first thickness.

### CROSS-REFERENCE TO RELATED APPLICATIONS

The present application claims priority to and incorporates by reference the entire contents of Japanese Patent Application No. 2011-144905 filed in Japan on Jun. 29, 2011.

### BACKGROUND OF THE INVENTION

1. Field of the Invention

The present invention relates to an image forming apparatus, an image forming method, and a computer-readable storage medium.

2. Description of the Related Art

An electrophotographic image forming apparatus scans a photosensitive element using a writing beam corresponding to image data to form a latent image on the photosensitive element, develops the latent image into a visualized image, transfers the visualized image onto an image recording medium, and fixes the image onto the image recording medium by heat and pressure. As a technique for transferring a visualized image onto an image recording medium, an electrophotographic image forming apparatus uses either direct transfer, in which the visualized image on the photosensitive element is directly transferred onto the image recording medium, or intermediate transfer, in which the visualized image on the photosensitive element is primarily transferred onto an intermediate transfer body, and then secondarily transferred from the intermediate transfer body onto the image recording medium. In both of these transfer techniques, when the linear speed of the surface of the image recording medium at a position where the visualized image is transferred changes, the scale factor of the sub-scanning direction of the visualized image transferred onto the image recording medium also changes (hereinafter, referred to as a sub-scanning scale factor), and image quality deteriorates.

Japanese Patent Application Laid-open No. 2010-266624 discloses a technology for suppressing a variation in the sub-scanning scale factor in a visualized image. In the technology disclosed in Japanese Patent Application Laid-open No. 2010-266624, a pattern formed on the intermediate transfer body is transferred onto the surface of the secondary transfer roller, and the sub-scanning direction lengths of the patterns before and after the transfer are compared in order to obtain an error in the sub-scanning scale factor caused by a linear speed variation of the surface of the secondary transfer roller. The rotation speed of the secondary transfer roller or the writing clock frequency of the optical writing unit is then corrected to reduce the error in the sub-scanning scale factor.

In the technology disclosed in Japanese Patent Application Laid-open No. 2010-266624, an error in the sub-scanning scale factor in the visualized image is obtained from the sub-scanning direction length of the pattern formed on the surface of the secondary transfer roller, and the error is reduced by correcting the rotation speed of the secondary transfer roller or the writing clock frequency. This method fails to suppress a variation in the sub-scanning scale factor in the visualized image caused by a variation of the thickness of image forming media. Furthermore, when the rotation speed of the secondary transfer roller is corrected to correct a sub-scanning scale factor particularly in the middle of continuous printing, a change in the rotation speed of the secondary transfer roller affects the speed of the intermediate transfer belt, whereby a disturbance might occur in a toner image that is primarily transferred onto the intermediate transfer belt.

Therefore, there is a need for an image forming apparatus, an image forming method, and a computer-readable storage medium that can form high-quality images even when the thickness of image recording media changes.

### SUMMARY OF THE INVENTION

It is an object of the present invention to at least partially solve the problems in the conventional technology.

According to an embodiment, there is provided an image forming apparatus that includes a light-emitting element configured to output a writing beam based on image data; a photosensitive element; a polygon mirror configured to scan the photosensitive element with the writing beam; a developing unit configured to develop a latent image formed by the writing beam on the photosensitive element to form a visualized image corresponding to the image data; a transfer unit configured to transfer the visualized image onto an image recording medium; a conveying unit configured to convey the image recording medium to a transfer position of the transfer unit; an acquiring unit configured to acquire thickness information indicating thickness of the image recording medium to be conveyed to the transfer position; and a writing control unit configured to control, when the thickness of the image recording medium conveyed to the transfer position changes from a first thickness to a second thickness, a rotation speed of the polygon mirror and a writing clock frequency that is a reference of output timing of the writing beam so that a sub-scanning direction scale factor of the visualized image transferred onto the image recording medium having the second thickness is matched to a sub-scanning direction scale factor of the visualized image transferred onto the image recording medium having the first thickness.

According to another embodiment, there is provided an image forming method performed by an image forming apparatus including a light-emitting element configured to output a writing beam based on image data, a photosensitive element, a polygon mirror configured to scan the photosensitive element with the writing beam, a developing unit configured to develop a latent image formed by the writing beam on the photosensitive element to form a visualized image corresponding to the image data, a transfer unit configured to transfer the visualized image onto an image recording medium, and a conveying unit configured to convey the image recording medium to a transfer position of the transfer unit. The image forming method includes acquiring thickness information indicating thickness of the image recording medium conveyed to the transfer position; and controlling, when the thickness of the image recording medium conveyed to the transfer position changes from a first thickness to a second thickness, a rotation speed of the polygon mirror and a writing clock frequency that is a reference of output timing of the writing beam so that a sub-scanning direction scale factor of the visualized image transferred onto the image recording medium having the second thickness is matched to a sub-scanning direction scale factor of the visualized image transferred onto the image recording medium having the first thickness.

According to still another embodiment, there is provided a non-transitory computer-readable storage medium with an executable program stored thereon for an image forming apparatus that includes a light-emitting element configured to output a writing beam based on image data, a photosensitive element, a polygon mirror configured to scan the photosensitive element with the writing beam, a developing unit configured to develop a latent image formed by the writing beam on the photosensitive element to form a visualized image corresponding to the image data, a transfer unit configured to transfer the visualized image onto an image recording medium, and a conveying unit configured to convey the image recording medium to a transfer position of the transfer unit. The program instructs a processor of the image forming apparatus to perform acquiring thickness information indicating thickness of the image recording medium conveyed to the transfer position; and controlling, when the thickness of the image recording medium conveyed to the transfer position changes from a first thickness to a second thickness, a rotation speed of the polygon mirror and a writing clock frequency that is a reference of output timing of the writing beam so that a sub-scanning direction scale factor of the visualized image transferred onto the image recording medium having the second thickness is matched to a sub-scanning direction scale factor of the visualized image transferred onto the image recording medium having the first thickness.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a structure of an image forming apparatus according to an embodiment of the present invention;

FIG. 2 is a schematic of a structure of an optical writing unit included in the image forming apparatus;

FIG. 3 is an enlarged view of a transfer position formed by a secondary transfer roller;

FIG. 4 is a schematic for explaining a relationship between the thickness of an image recording medium and a sub-scanning scale factor in a toner image secondarily transferred onto the image recording medium;

FIG. 5 is a functional block diagram illustrating a functional configuration of a system controller; and

FIG. 6 is a flowchart illustrating writing control process performed by the system controller.

### DETAILED DESCRIPTION OF THE PREFERRED EMBODIMENTS

An image forming apparatus, an image forming method, and a computer program according to an exemplary embodiment of the present invention will now be explained in detail with reference to the appended drawings. In the explanation below, an image forming apparatus to which the present invention is applied will be explained as an intermediate transfer and tandem-type color laser printer, as an example.

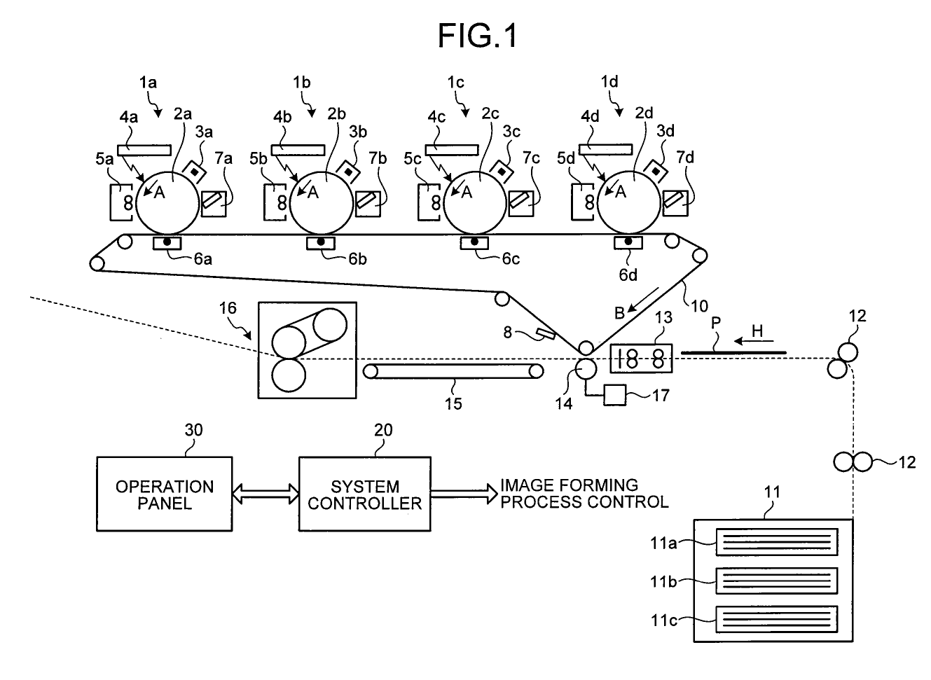

FIG. 1 is a schematic of a structure of the image forming apparatus according to an embodiment. The image forming apparatus according to the embodiment is an image forming apparatus that forms a full-color image in four colors, and is especially suited for an application for production printing in which a large number of recording media are carried continuously and printed at a high speed. As illustrated in FIG. 1, the image forming apparatus includes four image forming units 1a, 1b, 1c, 1d arranged along the running direction of an intermediate transfer belt 10 (in the direction of the arrow B illustrated in FIG. 1).

The image forming unit 1a includes a photosensitive drum 2a, a photosensitive element charging unit 3a, an optical writing unit 4a, a developing unit 5a, a primary transfer unit 6a, and a cleaning unit 7a. The image forming units 1b to 1d also include photosensitive drums 2b to 2d, photosensitive element charging units 3b to 3d, optical writing units 4b to 4d, developing units 5b to 5d, primary transfer units 6b to 6d, and cleaning units 7b to 7d, respectively, in the same manner as the image forming unit 1a. The image forming unit 1a to 1d form images in different colors. For example, the image forming unit 1a forms yellow images, the image forming unit 1b forms magenta images, the image forming unit 1c forms cyan images, and the image forming unit 1d forms black images.

The photosensitive drum 2a is rotated in the direction of the arrow A illustrated in FIG. 1 when an image is to be formed, and continues being rotated until the image forming operation is completed. When the photosensitive drum 2a starts being rotated, a high voltage is applied to the photosensitive element charging unit 3a, and the surface of the photosensitive drum 2a is uniformly charged with a negative charge. The optical writing unit 4a then irradiates the charged surface of the photosensitive drum 2a with a laser beam (writing beam) based on image data, thereby forming an electrostatic latent image matching the image data on the photosensitive drum 2a. When the part of the photosensitive drum 2a on which the electrostatic latent image is formed is carried by a rotation of the photosensitive drum 2a and reaches a position facing the developing unit 5a, the negatively charged toner from the developing unit 5a is attracted to the electrostatic latent image. In this manner, the electrostatic latent image is developed with the toner, and a toner image is formed on the photosensitive drum 2a.

When the toner image formed on the photosensitive drum 2a reaches a position facing the primary transfer unit 6a across the intermediate transfer belt 10, the toner image is attracted to the intermediate transfer belt 10 by an effect of the high voltage applied to the primary transfer unit 6a to become primarily transferred onto the intermediate transfer belt 10 moving in the direction of the arrow B illustrated in FIG. 1. Residual toner remaining on the photosensitive drum 2a without being transferred onto the intermediate transfer belt 10 is cleaned by the cleaning unit 7a.

Following the image forming unit 1a, the same image forming operation is performed in the image forming unit 1b, and the toner image formed on the photosensitive drum 2b is primarily transferred onto the intermediate transfer belt 10 by the effect of the high voltage applied to the primary transfer unit 6b. The toner image primarily transferred from the photosensitive drum 2b is then superimposed on the toner image primarily transferred from the photosensitive drum 2a on the intermediate transfer belt 10, by performing control to bring the toner image formed the photosensitive drum 2b to a position facing the primary transfer unit 6b at operational timing synchronized with the operation timing at which the toner image primarily transferred from the photosensitive drum 2a onto the intermediate transfer belt 10 is brought to the position of the primary transfer unit 6b by the movement of the intermediate transfer belt 10.

In the same manner, the toner image formed on the photosensitive drum 2c in the image forming unit 1c and the toner image formed on the photosensitive drum 2d in the image forming unit 1d are primarily transferred sequentially onto the intermediate transfer belt 10. In this manner, a full-color toner image is formed on the intermediate transfer belt 10.

In the image forming apparatus according to the embodiment, a paper feeding unit 11 for feeding an image recording medium P, conveying rollers 12, a registration unit 13, a secondary transfer roller 14, a carriage belt 15, and a fixing unit 16 are arranged along the conveying path of the image recording medium P.

The paper feeding unit 11 includes a plurality of paper feed trays 11a, 11b, and 11c each of which stores therein image recording media P having different thickness. The paper feeding unit 11 selects one of the paper feed trays 11a, 11b, and 11c and takes out and feeds an image recording medium P from the selected paper feed tray.

The image recording medium P fed by the paper feeding unit 11 is conveyed by the conveying rollers 12 in the direction of the arrow H illustrated in FIG. 1, and kept standby in the registration unit 13. At the operational timing at which the full-color toner image formed on the intermediate transfer belt 10 is carried by the moving intermediate transfer belt 10 to a position facing the secondary transfer roller 14, the image recording medium P kept standby in the registration unit 13 is fed into a position of the secondary transfer roller 14 (secondary transfer position), and the full-color toner image formed on the intermediate transfer belt 10 is secondarily transferred onto the image recording medium P by the effect of the high voltage applied to the secondary transfer roller 14 by a high-voltage power supply 17. The residual toner not secondarily transferred onto the image recording medium P and remaining on the intermediate transfer belt 10 is cleaned by a belt cleaning mechanism 8.

The image recording medium P on which the full-color toner image is secondarily transferred is conveyed by the carriage belt 15 into the fixing unit 16. The fixing unit 16 then fixes the full-color toner image secondarily transferred onto the image recording medium P onto the image recording medium P. The image recording medium P on which the toner image is fixed is discharged from the image forming apparatus.

These steps in the image forming process performed by the image forming apparatus are controlled by a system controller 20. The system controller 20 controls these steps of the image forming process based on a print job set up with an operation panel 30.

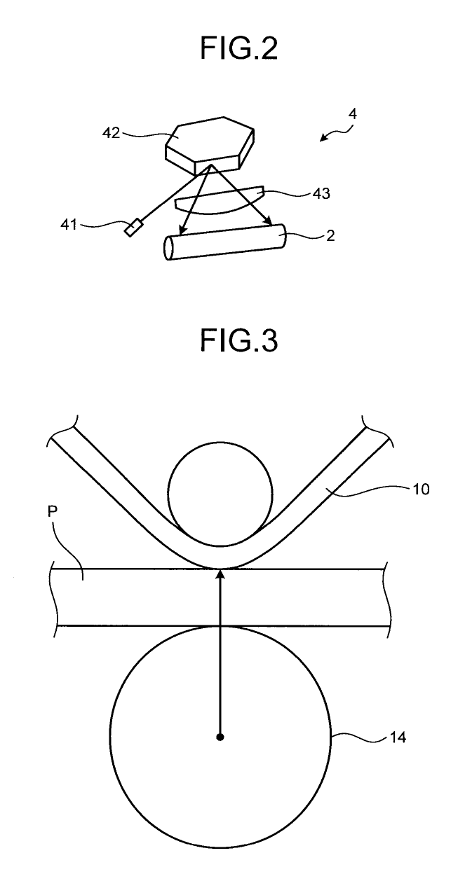

FIG. 2 is a schematic of a structure of the optical writing units 4a to 4d (hereinafter, any one of the optical writing units is referred to as an optical writing unit 4). The optical writing unit 4 includes a light-emitting element 41, a polygon mirror 42, and a correction lens 43.

The light-emitting element 41 outputs a laser beam (writing beam) corresponding to the image data, under the control of the system controller 20. The laser beam output from the light-emitting element 41 is reflected on the polygon mirror 42 that is driven in rotation by a polygon motor not illustrated, and irradiates the surface of the photosensitive drums 2a to 2d (hereinafter, any one of the photosensitive drums is referred to as a photosensitive drum 2). By being irradiated with the laser beam reflected on the rotating polygon mirror 42 and passed through the correction lens 43, the surface of the photosensitive drum 2 is scanned by laser beam in the main-scanning direction at a uniform velocity. Because the photosensitive drum 2 is rotated, the point irradiated with the laser beam and scanned at the uniform velocity moves in the sub-scanning direction. In this manner, an electrostatic latent image corresponding to the image data is formed on the surface of the photosensitive drum 2.

FIG. 3 is a schematic illustrating an enlarged view of the transfer position of the secondary transfer roller 14. The secondary transfer roller 14 and the intermediate transfer belt 10 nip the image recording medium P fed by the registration unit 13 into the secondary transfer position. The secondary transfer roller 14 secondarily transfers the full-color toner image formed on the intermediate transfer belt 10 onto the image recording medium P by the effect of the high voltage, while conveying the image recording medium P by being driven in rotation by a motor not illustrated. Because the velocity of the intermediate transfer belt 10 is constant, the moving velocity of the toner image on the intermediate transfer belt 10 is also constant. By contrast, the linear speed of the surface of the image recording medium P in the secondary transfer position is determined by the radius of the secondary transfer roller 14, the thickness of the image recording medium P, and the rotation speed of the secondary transfer roller 14. When the radius and the rotation speed of the secondary transfer roller 14 are constant, the linear speed of the surface of the image recording medium P in the secondary transfer position depends on the thickness of the image recording medium P, and therefore, when the thickness of the image recording medium P changes, the linear speed of the surface of the image recording medium P also changes. In other words, when the thickness of the image recording medium P is small, the linear speed of the surface of the image recording medium P in the secondary transfer position is large. By contrast, when the thickness of the image recording medium P is large, the linear speed of the surface of the image recording medium P in the secondary transfer position remains low.

If the toner image on the intermediate transfer belt 10 moving at a constant velocity is secondarily transferred onto the image recording medium P while the linear speed of the surface of the image recording medium P in the secondary transfer position is high, the toner image secondarily transferred onto the image recording medium P will become extended in the sub-scanning direction, that is, will have a large sub-scanning scale factor. By contrast, if the linear speed of the surface of the image recording medium P in the secondary transfer position is low, the toner image secondarily transferred onto the image recording medium P will be shrunk in the sub-scanning direction, that is, will have a smaller sub-scanning scale factor. In other words, when the thickness of the image recording medium P is small, the sub-scanning scale factor of the toner image secondarily transferred onto the image recording medium P is increased. If the thickness of the image recording medium P is large, the sub-scanning scale factor of the toner image secondarily transferred onto the image recording medium P is reduced.

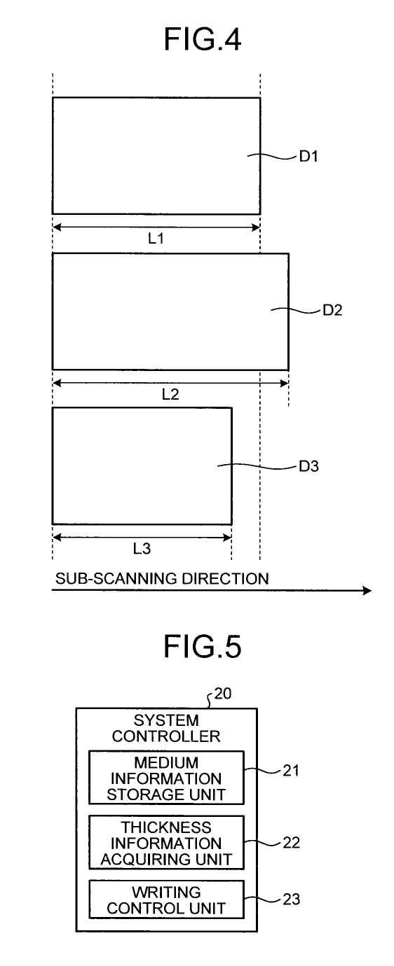

FIG. 4 is a schematic for explaining a relationship between the thickness of the image recording medium P and the sub-scanning scale factor of the toner image secondarily transferred onto the image recording medium P. D1 in FIG. 4 represents the toner image secondarily transferred onto the image recording medium P having an average thickness. D2 in FIG. 4 represents the toner image secondarily transferred onto the image recording medium P having a thickness smaller than the average thickness. D3 in FIG. 4 represents the toner image secondarily transferred onto the image recording medium P having a thickness larger than the average thickness. The toner image D2 and the toner image D3 before being secondarily transferred onto the image recording medium P have the same sub-scanning scale factor as the toner image D1.

As illustrated in FIG. 4, the toner image D1 secondarily transferred onto the image recording medium P at the average thickness has a length of L1 in the sub-scanning direction. By contrast, the toner image D2 secondarily transferred onto the image recording medium P having a thickness smaller than the average thickness has a length of L2, which is longer than L1, in the sub-scanning direction. In other words, when the thickness of the image recording medium P is smaller than the average thickness, the sub-scanning scale factor of the toner image secondarily transferred onto the image recording medium P is increased. The ratio of L2 with respect to L1 represents an error in the sub-scanning scale factor in the toner image D2.

By contrast, the toner image D3 secondarily transferred onto the image recording medium P having a thickness larger than the average thickness has a length of L3 that is shorter than L1 in the sub-scanning direction. In other words, when the thickness of the image recording medium P is larger than the average thickness, the sub-scanning scale factor of the toner image secondarily transferred onto the image recording medium P is reduced. The ratio of L3 with respect to L1 represents an error in the sub-scanning scale factor in the toner image D3.

In the image forming apparatus according to the embodiment, such an error in the sub-scanning scale factor in the toner image secondarily transferred onto the image recording medium P is corrected by controlling the writing operation performed by the optical writing unit 4 based on the thickness of the image recording medium P fed into the secondary transfer position. In other words, when the image recording medium P fed into the secondary transfer position is thin, the writing operation performed by the optical writing unit 4 is controlled so that the sub-scanning scale factor of the toner image on the intermediate transfer belt 10 before being secondarily transferred onto the image recording medium P is reduced in advance to cancel out the sub-scanning scale factor increase introduced in the process of the secondary transfer. In this manner, the error in the sub-scanning scale factor in the secondarily transferred toner image is corrected. By contrast, when the image recording medium P conveyed to the secondary transfer position is thick, the writing operation performed by the optical writing unit 4 is controlled so that the sub-scanning scale factor in the toner image on the intermediate transfer belt 10 before being secondarily transferred onto the image recording medium P is increased in advance, so that the sub-scanning scale factor decrease introduced in the process of the secondary transfer is cancelled out. In this manner, the sub-scanning scale factor error in the secondarily transferred toner image is corrected. Hereinafter, controlling the writing operation to correct an error in the sub-scanning scale factor in the toner image after being secondarily transferred is referred to as a writing control process. The writing control process is executed by the system controller 20.

FIG. 5 is a functional block diagram illustrating a functional configuration of the system controller 20 that executes a writing control process. As illustrated in FIG. 5, the system controller 20 includes, as functional units for executing the writing control process, a medium information storage unit 21, a thickness information acquiring unit 22, and a writing control unit 23. The medium information storage unit 21 is realized by using an internal storage of the system controller 20, for example. The thickness information acquiring unit 22 and the writing control unit 23 are realized by causing the system controller 20 to execute a pre-installed computer program.

The medium information storage unit 21 stores therein attribute information of the image recording media P stored in the respective paper feed trays 11a, 11b, and 11c in the paper feeding unit 11. The attribute information includes thickness information representing the thickness of the image recording media P. The attribute information of the image recording medium P stored in each of the paper feed trays 11a, 11b, and 11c is stored in the medium information storage unit 21, based on an input from the operation panel 30, for example. To change the type of the image recording media P stored in one of the paper feed trays 11a, 11b, and 11c, for example, an operator inputs a paper feed tray number to which such a change is applied and identification information of the image recording medium P after the change using the operation panel 30. In this manner, the attribute information of the image recording medium P stored in the medium information storage unit 21 is rewritten.

To control the feeding operation of the paper feeding unit 11, the system controller 20 can determine which of the paper feed trays stores therein the image recording medium P specified in a print job by referring to the medium information storage unit 21, and instruct the paper feeding unit 11 of a selection of the paper feed trays.

The thickness information acquiring unit 22 acquires the thickness information indicating the thickness of the image recording medium P conveyed to the secondary transfer position. Specifically, for example, the thickness information acquiring unit 22 reads the attribute information of the image recording medium P specified in a print job from the medium information storage unit 21, and acquires the thickness of the image recording medium P conveyed to the secondary transfer position. When a print job specifies continuous printing and specifies a plurality of types of image recording media P, the thickness information acquiring unit 22 acquires the thickness information of all of the image recording media P specified in the print job.

The writing control unit 23 continuously monitors changes of the thickness of the image recording medium P conveyed to the secondary transfer position based on the thickness information of the image recording medium P acquired by the thickness information acquiring unit 22. When the writing control unit 23 determines that the thickness of the image recording medium P conveyed to the secondary transfer position will change, the writing control unit 23 controls the writing clock frequency that is used as a reference for the rotation speed of the polygon mirror 42 in the optical writing unit 4 and operational timing at which the writing beam is output from the light-emitting element 41, so that the sub-scanning scale factor in the toner secondarily transferred onto the image recording medium P having a thickness after the change is matched to the sub-scanning scale factor in the toner image secondarily transferred onto the image recording medium P having a thickness before the change.

Specifically, assuming that a first thickness is the thickness before a change and a second thickness is the thickness after the change, when the second thickness is larger than the first thickness, the writing control unit 23 lowers the rotation speed of the polygon mirror 42 and the writing clock frequency based on the difference between the first thickness and the second thickness. When the second thickness is smaller than the first thickness, the writing control unit 23 increases the rotation speed of the polygon mirror 42 and the writing clock frequency based on the difference between the first thickness and the second thickness. A relationship between a change in the thickness of the image recording medium P and the amount of the change of the rotation speed of the polygon mirror 42 is determined depending on the configuration of the image forming apparatus. In the embodiment, as an example, when the second thickness is approximately twice of the first thickness, the rotation speed of the polygon mirror 42 is reduced by approximately 0.2%, and when the second thickness is approximately a half of the first thickness, the rotation speed of the polygon mirror 42 is increased by approximately 0.2%.

Because the rotation speed of the photosensitive drum 2 is constant, if the rotation speed of the polygon mirror 42 is reduced, the scanning speed of the laser beam for scanning in the main-scanning direction across the surface of the photosensitive drum 2 is reduced as well. Therefore, the sub-scanning scale factor of the electrostatic latent image formed on the photosensitive drum 2 is increased. At this time, if the writing clock frequency is constant, because the scale factor of the electrostatic latent image formed on the surface of the photosensitive drum 2 in the main-scanning direction is also increased. Therefore, by reducing the writing clock frequency, as well as the rotation speed of the polygon mirror 42, an electrostatic latent image in which only the sub-scanning scale factor is increased is formed without changing the main-scanning direction scale factor. By developing and primarily transferring this electrostatic latent image onto the intermediate transfer belt 10, a toner image in which only the sub-scanning scale factor is increased is formed on the intermediate transfer belt 10. By secondarily transferring the toner image on the intermediate transfer belt 10 onto the image recording medium P, the sub-scanning scale factor error in the secondarily transferred toner image caused by an increase in the thickness of the image recording medium P can be corrected, and a high-quality image can be formed.

When the rotation speed of the polygon mirror 42 is increased, the scanning speed of the laser beam for scanning in the main-scanning direction across the surface of the photosensitive drum 2 is increased as well. Therefore, the sub-scanning scale factor of the electrostatic latent image formed on the surface of the photosensitive drum 2 is reduced. At this time, if the writing clock frequency is constant, the scale factor in the electrostatic latent image formed on the surface of the photosensitive drum 2 in the main-scanning direction is also reduced. Therefore, by increasing the writing clock frequency, as well as the rotation speed of the polygon mirror 42, an electrostatic latent image in which only the sub-scanning scale factor is reduced is formed without changing the main-scanning direction scale factor. By developing and primarily transferring this electrostatic latent image onto the intermediate transfer belt 10, a toner image in which only the sub-scanning scale factor is reduced is formed on the intermediate transfer belt 10. By secondarily transferring the toner image on the intermediate transfer belt 10 onto the image recording medium P, the sub-scanning scale factor error in the secondarily transferred toner image caused by a decrease in the thickness of the image recording medium P can be corrected, and a high-quality image can be formed.

Because the polygon mirror 42 is driven in rotation by the polygon motor, when the rotation speed of the polygon mirror 42 is changed, it takes some time for the polygon mirror 42 to be stable at the rotation speed after the change. If writing is performed with the laser beam while the rotation speed of the polygon mirror 42 is not stable, an image disturbance occurs in the electrostatic latent image formed on the surface of the photosensitive drum 2. Therefore, when the rotation speed of the polygon mirror 42 is changed, the writing control unit 23 outputs a writing withholding request to the optical writing unit 4, thereby temporarily stopping the light-emitting element 41 from outputting the writing beam until the rotation speed of the polygon mirror 42 is stable at the rotation speed after the change. After the rotation speed of the polygon mirror 42 is stable at the rotation speed after the change, the writing control unit 23 outputs a writing starting request to the optical writing unit 4, and causes the light-emitting element 41 to output the writing beam.

The optical writing unit 4 includes a rotation speed monitoring unit, not illustrated, for monitoring the rotation speed of the polygon motor that drives the polygon mirror 42. Once the rotation speed of the polygon motor is stable at a specified rotation speed, the rotation speed monitoring unit outputs a locking signal for stabilizing the rotation of the polygon motor at the rotation speed to the writing control unit 23. When the rotation speed of the polygon mirror 42 is to be changed, the writing control unit 23 changes the setting of the rotation speed of the polygon motor. When the locking signal is received from the rotation speed monitoring unit, the writing control unit 23 outputs a writing starting request to the optical writing unit 4, and causes the light-emitting element 41 to output the writing beam.

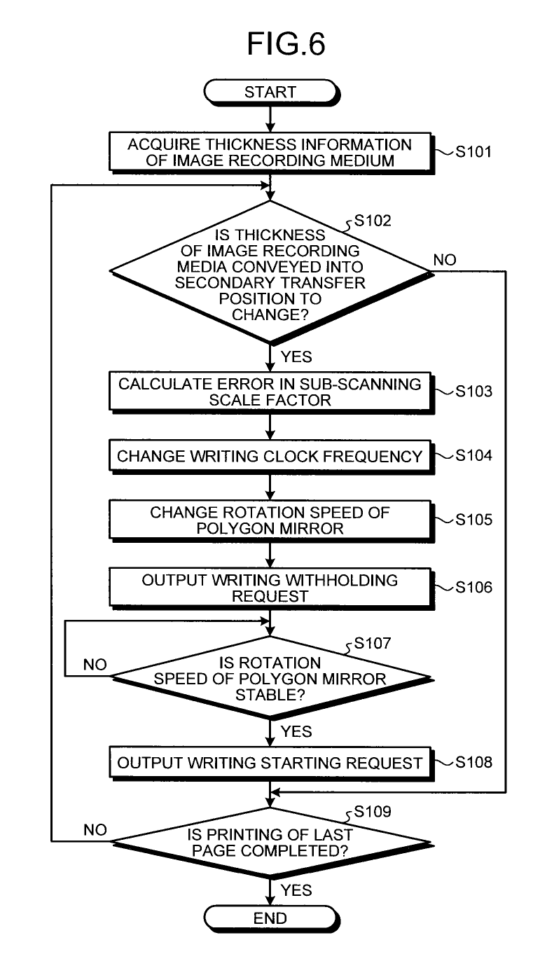

Explained now with reference to FIG. 6 is the writing control process performed when the continuous printing is executed using a plurality of types of image recording media P having different thickness. FIG. 6 is a flowchart illustrating the writing control process performed by the system controller 20. The system controller 20 checks a print job set through the operation panel 30. If the print job to be executed is continuous printing using a plurality of types of image recording media P having different thickness, the system controller 20 executes the writing control process illustrated in the flowchart of FIG. 6.

Once the writing control process is started, the thickness information acquiring unit 22 is caused to read the attribute information of all of the image recording media P specified in the print job from the medium information storage unit 21, and acquires the thickness information of all of the image recording media P specified in the print job (Step S101).

The writing control unit 23 then determines if the thickness of the image recording medium P conveyed to the secondary transfer position is to change based on the thickness information of the image recording media P acquired by the thickness information acquiring unit 22 (Step S102). When the print job specifies continuous printing, an image recording medium P to be used is specified for each page. Therefore, the writing control unit 23 can determine if the thickness of the image recording media P conveyed to the secondary transfer position is to change based on the number of pages to be printed. If the writing control unit 23 determines that the thickness of the respective image recording media P conveyed to the secondary transfer position is to change (Yes at Step S102), the system control goes to Step S103. If not (No at Step S102), the system control goes to S109.

If the writing control unit 23 determines that the thickness of the image recording media P conveyed to the secondary transfer position is to change, the writing control unit 23 calculates the error in the sub-scanning scale factor in the toner image secondarily transferred onto the image recording medium P having a thickness after the change, based on the ratio between the thickness before the change and the thickness after the change (Step S103). The writing control unit 23 then changes the writing clock frequency so as to reduce the error in the sub-scanning scale factor calculated at Step S103, and changes the rotation speed of the polygon mirror 42 as well (Step S104, Step S105).

The writing control unit 23 then outputs a writing withholding request to the optical writing unit 4, thereby temporarily stopping the light-emitting element 41 from outputting the writing beam (Step S106). The writing control unit 23 then determines if the polygon mirror 42 is stable at the rotation speed after the change by monitoring for a locking signal output from the rotation speed monitoring unit included in the optical writing unit 4 (Step S107). While the locking signal is not output from the rotation speed monitoring unit (No at Step S107), the writing control unit 23 repeats the determination at Step S107. Once the locking signal is output from the rotation speed monitoring unit and the writing control unit 23 determines that the rotation speed of the polygon mirror 42 is stable (Yes at Step S107), the writing control unit 23 outputs a writing starting request to the optical writing unit 4 to cause the light-emitting element 41 to output the writing beam (Step S108).

The writing control unit 23 then determines if the last page in the print job is completed (Step S109). If printing of the last page is not completed (No at Step S109), the system control returns to Step S102 and subsequent steps are repeated. By contrast, if printing of the last page is completed (Yes at Step S109), the writing control process illustrated in the flowchart of FIG. 6 is ended.

As explained above in detail using some specific examples, in the image forming apparatus according to the embodiment, the system controller 20 acquires the thickness information of the image recording media P conveyed to the secondary transfer position, and controls the rotation speed of the polygon mirror 42 and the writing clock frequency based on a change in the thickness of the respective image recording media P conveyed to the secondary transfer position. In this manner, an error in the sub-scanning scale factor in the secondarily transferred toner image caused by a change in the thickness of the image recording media P is suppressed. Therefore, high-quality images can be formed even if the thickness of the image recording media P changes.

Furthermore, in the image forming apparatus according to the embodiment, after changing the rotation speed of the polygon mirror 42, the system controller 20 outputs a writing withholding request to the optical writing unit 4, thereby temporarily stopping the light-emitting element 41 from outputting the writing beam until the polygon mirror 42 is stable at the rotation speed after the change. Therefore, it is possible to suppress any image disturbance caused when writing is performed with a laser beam while the rotation speed of the polygon mirror 42 is not stable, effectively.

Furthermore, in the image forming apparatus according to the embodiment, the system controller 20 determines if the rotation speed of the polygon mirror 42 is stable based on a locking signal output from a rotation speed monitoring unit already existing in the optical writing unit 4. Therefore, the system controller 20 can determine if the rotation speed of the polygon mirror 42 is stable simply and precisely, without any additional new structure.

Furthermore, in the image forming apparatus according to the embodiment, the medium information storage unit 21 stores therein attribute information of the image recording media P stored in the paper feed trays 11a, 11b, and 11c included in the paper feeding unit 11, and the system controller 20 reads the attribute information of the image recording media P specified in a print job from the medium information storage unit 21, thereby acquiring the thickness information of the image recording medium P conveyed to the secondary transfer position. Therefore, information about the thickness of the image recording medium P conveyed to the secondary transfer position can be acquired simply and precisely.

The writing control process in the image forming apparatus according to the embodiment is realized by the system controller 20 executing a computer program, for example. The system controller 20 includes basic components of a computer, such as a central processing unit (CPU), a random access memory (RAM), and a read-only memory (ROM). The writing control process is realized by the CPU executing a computer program pre-installed in the ROM, using the RAM as a working area. The image forming program executed by the CPU in the system controller 20 may also be provided in a manner recorded in a computer-readable recording medium such as a compact disk read-only memory (CD-ROM), a flexible disk (FD), a compact disk recordable (CD-R), and a digital versatile disk (DVD), as a file in an installable or executable format.

Furthermore, the image forming program executed by the CPU in the system controller 20 may be stored in a computer connected to a network such as the Internet, and may be made available for download over the network. The image forming program executed by the CPU in the system controller 20 may also be provided or distributed over a network such as the Internet.

The image forming program executed by the CPU in the system controller 20 has a modular structure including the thickness information acquiring unit 22 and the writing control unit 23. As actual hardware, for example, by causing CPU to read a computer program from the ROM and to execute the computer program, each of the thickness information acquiring unit 22 and the writing control unit 23 are loaded onto the RAM, and are generated on the RAM.

One specific embodiment of the present invention is as explained above, but the present invention is not limited to the exact specific embodiment as explained. Upon implementing the present invention, the present invention may be embodied with some additional variations, within the scope not deviating from the spirit of the present invention.

For example, in the embodiment explained above, the thickness information of the image recording medium P conveyed to the secondary transfer position is acquired from the attribute information of the image recording media P in the paper feed tray 11a to 11c stored in the medium information storage unit 21. Alternatively, a sensor for detecting the thickness of the image recording medium P may be provided in the conveying path of the image recording medium P, and a value detected by the sensor may be input to the thickness information acquiring unit 22 to allow the thickness information of the image recording medium P to be acquired. This method is particularly suitable to a structure in which the length of the conveying path from the paper feeding unit 11 to the registration unit 13 is long, and the image recording medium P is passed through the position of the sensor before being irradiated with the writing beam from the optical writing unit 4. As a sensor for detecting the thickness of the image recording medium P, for example, a known transmissive optical sensor that detects the thickness of an image recording medium P from the amount of light transmitted through the image recording medium P can be utilized effectively.

Furthermore, in the embodiment described above, stabilization of the rotation speed of the polygon mirror 42 is determined based on the locking signal output from the rotation speed monitoring unit included in the optical writing unit 4. Alternatively, such determination may be made based on whether the time elapsed from when the polygon mirror 42 is started to be driven at the rotation speed after the change reaches a predetermined time which determined depending how much the rotation speed is changed. In the structure explained in the embodiment, when the rotation speed of the polygon mirror 42 is changed by about 1%, the time required for the polygon mirror 42 to be stable at the rotation speed after the change is about 100 milliseconds. When the rotation speed of the polygon mirror 42 is changed by a larger degree, the time required for the polygon mirror 42 to be stable at the rotation speed after the change will be longer. Therefore, the relationship between the degree of a change in the rotation speed and the time may be prepared in advance, and the time used in determining whether the rotation speed of the polygon mirror 42 is stable may be decided accordingly.

Furthermore, in the embodiment described above, when the rotation speed of the polygon mirror 42 is changed, the writing control unit 23 outputs a writing withholding request to the optical writing unit 4 to temporarily stop the light-emitting element 41 from outputting the writing beam. If the time until when the optical writing unit 4 starts writing the next image to the photosensitive drum 2 is longer than the time required for the rotation speed of the polygon mirror 42 to be stable, the light-emitting element 41 does not need to be stopped from outputting the writing beam. Therefore, when the writing control unit 23 changes the rotation speed of the polygon mirror 42, the writing control unit 23 may compare the time until when the optical writing unit 4 starts writing an image with the time required for the rotation speed of the polygon mirror 42 to be stable, and output a writing withholding request to the optical writing unit 4 to temporarily stop the light-emitting element 41 from outputting the writing beam only when the time until when the optical writing unit 4 starts writing an image is longer than the time required for the rotation speed of the polygon mirror 42 to be stable.

Furthermore, although the embodiment described above assumes that a print job executed by the image forming apparatus specifies continuous printing, the present invention can also be applied effectively to printing to a single sheet. For example, when printing is to be performed using an image recording medium P having a non-standard thickness while the rotation speed of the polygon mirror 42 and the writing clock frequency are set to most suitable settings for an image recording medium P having a standard thickness to be used in printing, the thickness information of the image recording medium P to be used in printing may be acquired, and the rotation speed of the polygon mirror 42 and the writing clock frequency may be changed based on a degree of change with respect to the standard thickness.

Furthermore, in the example explained in the embodiment, the present invention is applied to an intermediate-transfer type image forming apparatus in which the toner image on the photosensitive drum 2 is primarily transferred onto the intermediate transfer belt 10, and then secondarily transferred onto the image recording medium P. The present invention can also be applied effectively to a direct-transfer type image recording apparatus in which the toner image on the photosensitive element is directly transferred onto an image recording medium.

According to the embodiment, a sub-scanning scale factor variation in a visualized image transferred onto an image recording medium is suppressed by controlling the rotation speed of the polygon mirror and the writing clock frequency based on a change in the thickness of the image recording medium conveyed to the transfer position. Therefore, high-quality images can be formed even if the thickness of the image recording medium changes.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a light-emitting element configured to output a writing beam based on image data;
a photosensitive element;
a polygon mirror configured to scan the photosensitive element with the writing beam;
a developing unit configured to develop a latent image formed by the writing beam on the photosensitive element to form a visualized image corresponding to the image data;
a transfer unit configured to transfer the visualized image onto an image recording medium;
a conveying unit configured to convey the image recording medium to a transfer position of the transfer unit;
an acquiring unit configured to acquire thickness information indicating thickness of the image recording medium to be conveyed to the transfer position; and
a writing control unit configured to control, when the thickness of the image recording medium conveyed to the transfer position changes from a first thickness to a second thickness, a rotation speed of the polygon mirror and a writing clock frequency that is a reference of output timing of the writing beam so that a sub-scanning direction scale factor of the visualized image transferred onto the image recording medium having the second thickness is matched to a sub-scanning direction scale factor of the visualized image transferred onto the image recording medium having the first thickness.

2. The image forming apparatus according to claim 1, wherein, when the second thickness is larger than the first thickness, the writing control unit reduces the rotation speed of the polygon mirror and the writing clock frequency, and when the second thickness is smaller than the first thickness, the writing control unit increases the rotation speed of the polygon mirror and the writing clock frequency.

3. The image forming apparatus according to claim 2, wherein, when the rotation speed of the polygon mirror is changed, the writing control unit temporarily stops the light-emitting element from outputting the writing beam until the rotation speed of the polygon mirror is stable.

4. The image forming apparatus according to claim 3, further comprising:
a rotation speed monitoring unit configured to output a locking signal when the rotation speed of the polygon mirror is stable, wherein
when the rotation speed monitoring unit outputs the locking signal, the writing control unit causes the light-emitting element to start outputting the writing beam.

5. The image forming apparatus according to claim 1, further comprising:
a feeding unit including a plurality of paper feed trays storing therein image recording media having different thickness, the feeding unit being configured to take out and feed an image recording medium from one of the paper feed trays in a selective manner; and
a storage unit configured to store therein thickness information of the image recording media stored in the paper feed trays included in the feeding unit, wherein
the acquiring unit acquires the thickness information of image recording media stored in the paper feed tray selected by the feeding unit from the storage unit, as thickness information of an image recording medium to be conveyed to the transfer position.

6. The image forming apparatus according to claim 1, further comprising:
an intermediate transfer body onto which the visualized image on the photosensitive element is primarily transferred, wherein
the transfer unit includes a rotating body abutting against the intermediate transfer body across the image recording medium, and secondarily transfers the visualized image primarily transferred onto the intermediate transfer body onto the image recording medium, while conveying the image recording medium by rotation of the rotating body.

7. An image forming method performed by an image forming apparatus including a light-emitting element configured to output a writing beam based on image data, a photosensitive element, a polygon mirror configured to scan the photosensitive element with the writing beam, a developing unit configured to develop a latent image formed by the writing beam on the photosensitive element to form a visualized image corresponding to the image data, a transfer unit configured to transfer the visualized image onto an image recording medium, and a conveying unit configured to convey the image recording medium to a transfer position of the transfer unit, the image forming method comprising:
acquiring thickness information indicating thickness of the image recording medium conveyed to the transfer position; and
controlling, when the thickness of the image recording medium conveyed to the transfer position changes from a first thickness to a second thickness, a rotation speed of the polygon mirror and a writing clock frequency that is a reference of output timing of the writing beam so that a sub-scanning direction scale factor of the visualized image transferred onto the image recording medium having the second thickness is matched to a sub-scanning direction scale factor of the visualized image transferred onto the image recording medium having the first thickness.

8. A non-transitory computer-readable storage medium with an executable program stored thereon for an image forming apparatus that includes a light-emitting element configured to output a writing beam based on image data, a photosensitive element, a polygon mirror configured to scan the photosensitive element with the writing beam, a developing unit configured to develop a latent image formed by the writing beam on the photosensitive element to form a visualized image corresponding to the image data, a transfer unit configured to transfer the visualized image onto an image recording medium, and a conveying unit configured to convey the image recording medium to a transfer position of the transfer unit, wherein the program instructs a processor of the image forming apparatus to perform:
acquiring thickness information indicating thickness of the image recording medium conveyed to the transfer position; and
controlling, when the thickness of the image recording medium conveyed to the transfer position changes from a first thickness to a second thickness, a rotation speed of the polygon mirror and a writing clock frequency that is a reference of output timing of the writing beam so that a sub-scanning direction scale factor of the visualized image transferred onto the image recording medium having the second thickness is matched to a sub-scanning direction scale factor of the visualized image transferred onto the image recording medium having the first thickness.
